(19) United States
(12) Patent Application Publication
(10) Pub. No.: US 2022/0052841 A1
(43) Pub. Date: Feb. 17, 2022

(54) MATCHING SYSTEM, CLIENT AND SERVER

(71) Applicant: NEC Corporation, Minato-ku, Tokyo (JP)

(72) Inventors: Haruna FUKUDA, Tokyo (JP); Toshiyuki ISSHIKI, Tokyo (JP); Hiroto TAMIYA, Tokyo (JP)

(73) Assignee: NEC Corporation, Minato-ku, Tokyo (JP)

(21) Appl. No.: 17/298,819

(22) PCT Filed: Dec. 12, 2018
(86) PCT No.: PCT/JP2018/045776

§ 371 Date: Jun. 1, 2021

(51) Int. Cl. H04L 9/08; H04L 9/32

(52) U.S. Cl. CPC H04L 9/0825; H04L 9/3231; H04L 9/085

(57) ABSTRACT

A matching system in which leakage of the registration information from the client can be prevented, even when the concealed information generated from registration information is stored in the client, is provided. The concealed information storage unit 15 of the client 1 stores concealed information generated by concealing registration information with a public key. The concealed evaluation value calculation unit 17 of the client 1 calculates a concealed evaluation value of an evaluation value indicating similarity between the registration information and matching information input for matching with the registration information, based on the matching information and the concealed information. The determination unit 25 of the server 2 determines whether the matching information and the registration information match or not, based on the evaluation value obtained by cancelling concealment of the concealed evaluation value received from the evaluation value transmission unit 18.

### TECHNICAL FIELD

The present invention relates to a matching system, a matching method and an information storage method, and a client, a server, a program for a client, and a program for a server, applied to the matching system.

### BACKGROUND ART

One example of authentication means is biometric authentication. “Biometric authentication” is a method of personal authentication in which biometric information of the authenticated person is matched with biometric information of the registrants to confirm whether or not the authenticated person is matched with any one of the registrants.

“Biometric information” is data extracted from some characteristics of an individual regarding body and behavior, or data generated by transforming the extracted data. This data is sometimes referred to as a feature value.

A “template” is data generated from the biometric information (hereinafter, referred to as registration information) of a registrant that is stored in advance for biometric authentication.

To realize biometric authentication in a client-server system, templates can be stored either in the client, or the server.

Patent literature 1 and patent literature 2 describe an example of an authentication device and method in which encrypted registration information (template) is stored on a server so that the registration information is not leaked.

FIDO (Fast IDentity Online) is an example of storing a template in a client. In FIDO, a template is stored in the client in advance. When the biometric information of the user (the authenticated person) currently using the client is input to the client, the client determines whether the authenticated person corresponds to an registrant or not based on the input biometric information and the template. When the client determines that the authenticated person corresponds to the registrant, the server determines whether the signature key (secret key) of the client and the verification key (public key) of the server are a pair of keys based on the signature generated by the client using the signature key. In other words, in FIDO, when biometric authentication is successful at the client and verification of the signature of the client is successful at the server, the user (authenticated person) is finally determined to have been successfully authenticated.

In addition, in FIDO, the encrypted biometric information of the registrant is stored in advance in the client as a template. The key for decrypting the encrypted information is also stored in the client. When the biometric information of the authenticated person is input to the client, the client decrypts the template using the key, and determines whether the authenticated person corresponds to an registrant or not using the decrypted biometric information and the input biometric information.

In some cases, encrypted biometric information is stored in an IC (Integrated Circuit) chip of a cash card.

Here, what is protected as personal information is explained under “Act on the Protection of Personal Information (hereinafter, referred to as “personal information protection law”) in Japan. The personal information protection law in Japan stipulates that biometric information that can identify an individual is the personal information. Furthermore, the personal information protection law stipulates that personal information managed in an electronic database or a paper database is an object to be protected under the personal information protection law.

In cases where templates are stored in a server, it can be said that the templates of individual users who use individual clients are stored as a database in a common server. Therefore, the templates stored in the server are objects to be protected under the personal information protection law.

On the other hand, in cases of storing templates in a client, the client stores the templates of one or a few users who use the client. Accordingly, it cannot be said that the templates are stored as a database. Therefore, the templates stored in the client may not be protected according to the personal information protection law.

### CITATION LIST

### Patent Literature

Patent Literature 1: Japanese Patent Laid-Open No. 2011-211593

Patent Literature 2: Japanese Patent Laid-Open No. 2009-129292

### SUMMARY OF INVENTION

### Technical Problem

As mentioned above, templates stored in the client are not objects to be protected under the personal information protection law. However, biometric information is personal information that does not change in a lifetime of the person.

Even if biometric information is stored only in the client as a template for use in a service provided by a certain business, the manager of the business may be pursued liability if the biometric information is leaked.

In addition, there is a danger that biometric information may be leaked from the client, for example, if the client is infected with malware. However, this danger is difficult to eliminate through the efforts of service providers.

In FIDO, information, that the biometric information of the registrant is encrypted, is stored in the client as a template. However, when the biometric information of the authenticated person is input, the client decrypts the template with a key. At this time, there is a possibility that the biometric information decrypted from the template will be leaked. In addition, even when the template is not decrypted, if the template and the key are stolen together by a third party, the third party can obtain the biometric information by decrypting the template.

In addition, an IC chip of a cash card has tamper-resistant. However, when biometric authentication is performed outside the IC chip, if the encrypted biometric information stored in the IC chip is decrypted and transmitted outside the IC chip, there is a possibility that the decrypted biometric information will be leaked.

In light of the above, even when the template is stored in the client, it is preferable to prevent the leakage of the biometric information of the registrant (i.e., registration information), taking into account possibility that the template may be leaked from the client. In other words, it is preferable to prevent the leakage of the registration information from the template.

In addition, not only in the case of authentication by a biometric, but also in the case of authentication by a password or by a secret key stored in an IC card, it is desirable to prevent the leakage of registration information from the client, when a template generated from the password or secret key being the registration information is stored in the client of the client-server system.

Therefore, it is an object of the present invention to provide a matching system, a matching method and an information storage method, and a client, a server, a program for a client, and a program for a server, applied to the matching system, which can prevent leakage of registration information from the client, even when the client stores the concealed information generated by concealing registration information.

### Solution to Problem

A matching system according to the present invention is a matching system including a client and a server, wherein the client includes a concealed information storage unit which stores concealed information generated by concealing registration information with a public key, a concealed evaluation value calculation unit which calculates a concealed evaluation value of an evaluation value indicating similarity between the registration information and matching information input for matching with the registration information, based on the matching information and the concealed information, and a concealed evaluation value transmission unit which sends the concealed evaluation value to the server, and wherein the server includes a determination unit which determines whether the matching information and the registration information match or not, based on the evaluation value obtained by cancelling concealment of the concealed evaluation value received from the concealed evaluation value transmission unit with a secret key corresponding to the public key.

A matching system according to the present invention is a matching system including a client and a server, wherein the client includes a concealing unit which generates concealed information by concealing input registration information with a public key, and stores the concealed information to a concealed information storage unit.

A client according to the present invention includes a concealed information storage unit which stores concealed information generated by concealing registration information with a public key, a concealed evaluation value calculation unit which calculates a concealed evaluation value of an evaluation value indicating similarity between the registration information and matching information input for matching with the registration information, based on the matching information and the concealed information, and a concealed evaluation value transmission unit which sends the concealed evaluation value to a server.

A client according to the present invention includes a concealing unit which generates concealed information by concealing input registration information with a public key, and stores the concealed information to a concealed information storage unit.

A server according to the present invention includes a concealed evaluation value receiving unit which receives a concealed evaluation value of an evaluation value indicating similarity between registration information and matching information input for matching with the registration information from a client, and a determination unit which determines whether the matching information and the registration information match or not, based on the evaluation value obtained by cancelling concealment of the concealed evaluation value.

In a matching method according to the present invention, a client, which includes a concealed information storage unit which stores concealed information generated by concealing registration information with a public key, calculates a concealed evaluation value of an evaluation value indicating similarity between the registration information and matching information input for matching with the registration information, based on the matching information and the concealed information, and sends the concealed evaluation value to a server, and the server determines whether the matching information and the registration information match or not, based on the evaluation value obtained by cancelling concealment of the concealed evaluation value received from the client with a secret key corresponding to the public key.

In an information storage method according to the present invention, a client generates concealed information by concealing input registration information with a public key, and stores the concealed information to a concealed information storage unit.

A program for a client according to the present invention, implemented in a computer including a concealed information storage unit which stores concealed information generated by concealing registration information with a public key and performing as the client, causes the computer to execute an evaluation value calculation process of calculating a concealed evaluation value of an evaluation value indicating similarity between the registration information and matching information input for matching with the registration information, based on the matching information and the concealed information, and an evaluation value transmission process of sending the concealed evaluation value to a server.

A program for a client according to the present invention, implemented in a computer performing as the client, causes the computer to execute a concealing process of generating concealed information by concealing input registration information with a public key, and storing the concealed information to a concealed information storage unit.

A program for a server according to the present invention, implemented in a computer performing as the server, causing the computer to execute an evaluation value receiving process of receiving a concealed evaluation value of an evaluation value indicating similarity between registration information and matching information input for matching with the registration information from a client, and a determination process of determining whether the matching information and the registration information match or not, based on the evaluation value obtained by cancelling concealment of the concealed evaluation value.

### Advantageous Effects of Invention

According to the present invention, leakage of the registration information from the client can be prevented, even when the client stores the concealed information generated by concealing registration information.

### BRIEF DESCRIPTION OF DRAWINGS

FIG. 1 It depicts a block diagram showing a matching system of an example embodiment of the present invention.

FIG. 2 It depicts a flowchart showing an example of processing when storing a template in advance in a concealed information storage unit of a client.

FIG. 3 It depicts a flowchart showing an example of processing when authentication is performed.

FIG. 4 It depicts a flowchart showing an example of processing of calculating an encrypted Hamming distance.

FIG. 5 It depicts a flowchart showing an example of processing of calculating encrypted squared Euclidean distance.

FIG. 6 It depicts a flowchart showing an example of processing of calculating an encrypted inner product.

FIG. 7 It depicts a block diagram showing a configuration in which a client requests a public key to the server and a concealing unit generates a template using the public key, when the concealing unit generates a template.

FIG. 8 It depicts a schematic block diagram of a configuration example of a computer for each of a client and a server in an example embodiment or its modification.

FIG. 9 It depicts a block diagram showing a summarized matching system of the present invention.

### DESCRIPTION OF EMBODIMENTS

Hereinafter, an example embodiment of the present invention will be described with reference to the drawings. In the following description, the case where the matching system of the present invention is applied to biometric authentication is used as an example. However, the matching system of the present invention may be applied to authentication other than biometric authentication.

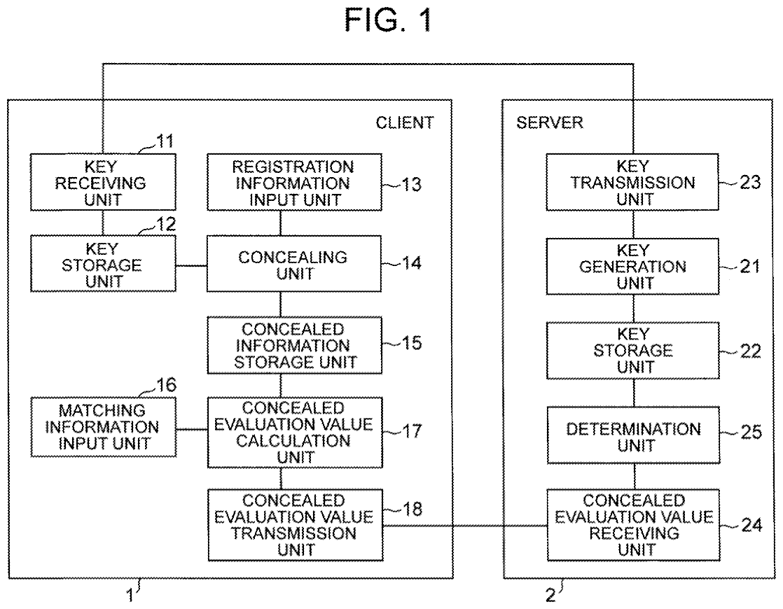

FIG. 1 is a block diagram showing a matching system of an example embodiment of the present invention. The matching system comprises a client 1 and a server 2. Although one client 1 is illustrated in FIG. 1, there may be multiple clients 1. The client 1 and the server 2 can communicate with each other through a communication network.

Client 1 comprises a key receiving unit 11, a key storage unit 12, a registration information input unit 13, a concealing unit 14, a concealed information storage unit 15, a matching information input unit 16, a concealed evaluation value calculation unit 17, and a concealed evaluation value transmission unit 18.

The key receiving unit 11 receives a public key generated by the server 2 and sent by the server 2, and stores the public key in the key storage unit 12. Hereinafter, this public key is referred to as pk.

The key storage unit 12 is a storage device that stores the public key pk.

The registration information input unit 13 receives input of registration information. In this example embodiment, biometric information of a registrant is input to the registration information input unit 13 as registration information.

In this example embodiment, the explanation is based on the case where the registration information and the matching information (information input for being matched with the registration information) described below are represented by vectors of a common dimension.

The registration information input unit 13 may be an input device depending on the registration information. For example, when biometric information extracted from a fingerprint is used as registration information, the registration information input unit 13 may be an input device that reads the fingerprint, extracts a vector that becomes registration information from the fingerprint, and accepts input of the vector. The registration information input unit 13 may also be an input device that directly inputs a vector that serves as registration information.

The biometric information may be extracted from iris, retina, face, blood vessels (veins), palm print, voice print, or a combination of these, other than fingerprint. The biometric information may also be extracted from other information that can identify a living body, other than the examples described above.

The vector corresponding to the biometric information (registration information) of the registrant input into the registration information input unit 13 is denoted by X.

The concealing unit 14 conceals the biometric information X of the registrant input into the registration information input unit 13, and stores the information (referred to as concealed information) generated by concealing biometric information X in the concealed information storage unit 15. The concealed information storage unit 15 is a storage device that stores the concealed information.

This concealed information is data generated from the biometric information of the registrant, which is stored in advance for biometric authentication. Therefore, this concealed information is a template. The public key pk is not a template because the public key pk stored in the key storage unit 12 is not data generated from the biometric information of the registrant.

In this example embodiment, encryption will be used as a specific example of concealment. Therefore, the concealing unit 14 encrypts the biometric information X of the registrant input into the registration information input unit 13, and stores the encrypted biometric information X (referred to as Enc(X)) in the concealed information storage unit 15. The concealing unit 14 encrypts the biometric information X of the registrant with the public key pk stored in the key storage unit 12.

Furthermore, in this example embodiment, the case where the concealment unit 14 encrypts the biometric information X of the registrant using an encryption method with additive homomorphism is explained as an example. Therefore, in this example, the public key pk is a public key in a public key cryptosystem with additive homomorphism.

The following is an explanation of characteristic of cryptosystem with additive homomorphism. In this explanation, the ciphertext obtained by encrypting the plaintext m with the public key pk is denoted as Enc(pk,m). When Enc(pk,m) is further expressed by another symbol (for example, c), it is written as Enc(pk,m)→c. In the following explanation, x and y are assumed to be numerical values in the plaintext domain and z is assumed to be integer in the plaintext domain.

In a cryptosystem with additive homomorphism, the ciphertext Enc(pk, x+y) of x+y can be calculated from the ciphertext c₁ of x by public key pk (i.e., Enc(pk,x)→c₁) and the ciphertext c₂ of y by public key pk (i.e., Enc(pk,y)→c₂). In the following, this operation is expressed as follows.

⊕ [Math. 1]

Therefore, the following equation (1) holds.

[Math. 2]

c₁⊕c₂=Enc(pk,x+y) (1)

By repeating the above operation, it is possible to calculate the ciphertext of x·z (i.e., Enc(pk, x·z)) from the ciphertext c₁ of x by public key pk (i.e., Enc(pk, x)→c₁) and integer z.

In the following, this operation is expressed as follows.

⊙ [Math. 3]

In other words, the following equation (2) holds.

[Math. 4]

c₁⊙z=Enc(pk,x·z) (2)

An example of a cryptosystem with additive homomorphism is the ECElgamal cryptosystem. Therefore, the ECElgamal cryptosystem may be adopted in the present invention. However, the ECElgamal cryptosystem is only one example, and any cryptosystem with additive homomorphism can be used in the present invention.

In this example embodiment, the concealment information storage unit 15 stores Enc(X), which is obtained by encrypting the biometric information X of the registrant by the public key pk of the public key cryptosystem with additive homomorphism, as a template. Various examples of Enc(X) stored as a template will be described later.

The information input for matching with the registration information is referred to as matching information. The matching information input unit 16 receives input of matching information. In this example embodiment, the biometric information of the authenticated person is input into the matching information input unit 16 as the matching information. As mentioned above, the registration information and the matching information are represented by vectors of a common dimension.

The matching information input unit 16 may be an input device depending on the matching information. For example, when biometric information extracted from a fingerprint is used as the matching information, the matching information input unit 16 may be an input device that reads the fingerprint, extracts a vector that serves as the matching information from the fingerprint, and accepts input of the vector. The matching information input unit 16 may also be an input device that directly inputs a vector that serve as matching information. In addition, the registration information input unit 13 and the matching information input unit 16 may be a common input device.

The vector corresponding to the biometric information (matching information) of the authenticated person that is input to the matching information input unit 16 is denoted by Y.

The concealed evaluation value calculation unit 17 calculates data (hereinafter, referred to as the concealed evaluation value) that is encryption of an evaluation value indicating similarity between the biometric information X of the registrant and the biometric information Y of the authenticated person, based on the biometric information Y of the authenticated person and the template (i.e., Enc(X) obtained by encrypting the biometric information X of the registrant). At this time, the concealed evaluation value calculation unit 17 calculates the concealed evaluation value without decrypting the template Enc(X).

Various specific examples of evaluation values of the similarity between the biometric information X and the biometric information Y will be described later.

The concealed evaluation value transmission unit 18 transmits the concealed evaluation value calculated by the concealed evaluation value calculation unit 17 to the server 2.

The key receiving unit 11 and the concealed evaluation value transmission unit 18 are realized, for example, by a CPU (Central Processing Unit) of a computer that operates according to a program for the client and a communication interface of the computer. For example, the CPU may read the program for the client from a program recording medium such as a program storage device of the computer, and operate as the key receiving unit 11 and the concealed evaluation value transmission unit 18 according to the program and using the communication interface. The concealing unit 14 and the concealed evaluation value calculation unit 17 are realized, for example, by the CPU of the computer that operates according to the program for the client. For example, the CPU may read the program for the client from the program recording medium as described above, and operate as the concealment unit 14 and the concealment evaluation value calculation unit 17 according to the program.

The key storage unit 12 and the concealed information storage unit 15 are realized, for example, by a storage device which the computer comprises.

The server 2 comprises a key generation unit 21, a key storage unit 22, a key transmission unit 23, a concealed evaluation value receiving unit 24, and a determination unit 25.

The key generation unit 21 generates the secret key and the public key pk described above. Hereinafter, this secret key is referred to as sk. Biometric information is not input into the server 2. Therefore, the key generation unit 21 generates the public key pk and the secret key sk independent of the biometric information X (in other words, without using the biometric information X). In addition, as already mentioned, in this example, the public key pk is a public key in a public key cryptosystem with additive homomorphism.

The key generation unit 21 generates the public key pk and the secret key sk using a parameter (called a security parameter) that indicates the strength of the key. This operation can be shown as follows, assuming that the security parameter is κ.

KeyGen (κ)→(pk, sk)

As described above, the fact that c is the ciphertext, which is generated by encrypting the plaintext message m with the public key pk, can be shown as follows.

Enc (pk, m)→c

The ciphertext is decrypted by the secret key sk. This can be shown as follows.

Dec(sk, c)→m

When the key generation unit 21 generates the public key pk and the secret key sk, it stores the public key pk and the secret key sk in the key storage unit 22.

The key storage unit 22 is a storage device that stores the public key pk and the secret key sk.

The key transmission unit 23 sends the public key pk generated by the key generation unit 21 to the client 1. The secret key sk is not sent to the client 1.

In this example embodiment, the case is explained as an example where the key generation unit 21 generates a set of public key pk and the secret key sk, and the key transmission unit 23 sends the same public key pk to each client 1.

The public key pk sent by the key transmission unit 23 to client 1 is received at the key receiving unit 11 of client 1 and stored in the key storage unit 12 of client 1.

The concealed evaluation value receiving unit 24 receives the concealed evaluation value sent by the concealed evaluation value transmission unit 18 of client 1.

The determination unit 25 decrypts the evaluation value from the concealed evaluation value (ciphertext of the evaluation value) received by the concealed evaluation value receiving unit 24 with the secret key stored in the key storage unit 22. It is noted that decryption can be said to be cancellation of the concealment. The evaluation value is a numerical value. The determination unit 25 determines whether the biometric information X and the biometric information Y match (in other words, whether the authenticated person corresponds to the registrant) or not by determining whether the evaluation value decrypted from the concealed evaluation value is within a predetermined range or not. Therefore, if the evaluation value decrypted from the concealed evaluation value is within the predetermined range, the determination unit 25 determines that the biometric information X and the biometric information Y match (in other words, the authenticated person corresponds to the registrant). If the evaluation value decrypted from the concealed evaluation value is not within the predetermined range, the determination unit 25 determines that the biometric information X and the biometric information Y do not match (in other words, the authenticated person does not correspond to the registrant).

As described above, it is determined whether biometric information X and the biometric information Y match or not, according to whether the evaluation value decrypted from the concealed evaluation value is within a predetermined range or not. Therefore, even if the biometric information X and the biometric information Y do not match perfectly (even if there is a small gap), if the evaluation value is within the predetermined range, the biometric information X and the biometric information Y can be determined to match. The process of using the predetermined range is an example of a process to determine that biometric information X and the biometric information Y match even if there is a small gap.

When the biometric information X and the biometric information Y match, the authentication is considered successful, and the post-authentication process can be executed. For example, as an example, the server 2 may send the determination result of the determination unit 25 to the client 1, and when the client 1 receives the determination result that the biometric information X and the biometric information Y match, the client 1 may assume that the authentication was successful and execute the post-authentication process. However, the device that performs the post-authentication process is not limited to the client 1. Any device other than the client 1 may perform the post-authentication process on the condition that the determination result that the biometric information X and the biometric information Y match is obtained.

The key transmission unit 23 and the concealed evaluation value receiving unit 24 are realized, for example, by a CPU of a computer that operates according to a program for the server and a communication interface of the computer. For example, the CPU may read the program for the server from a program recording medium such as a program storage device of the computer, and operate as the key transmission unit 23 and the concealed evaluation value receiving unit 24 using the communication interface according to the program. The key generation unit 21 and the determination unit 25 are realized, for example, by the CPU of the computer operating according to the program for the server. For example, the CPU can read the program for the server from the program recording medium as described above, and operate as the key generation unit 21 and the determination unit 25 according to the program.

The key storage unit 22 is realized, for example, by a storage device which the computer comprises.

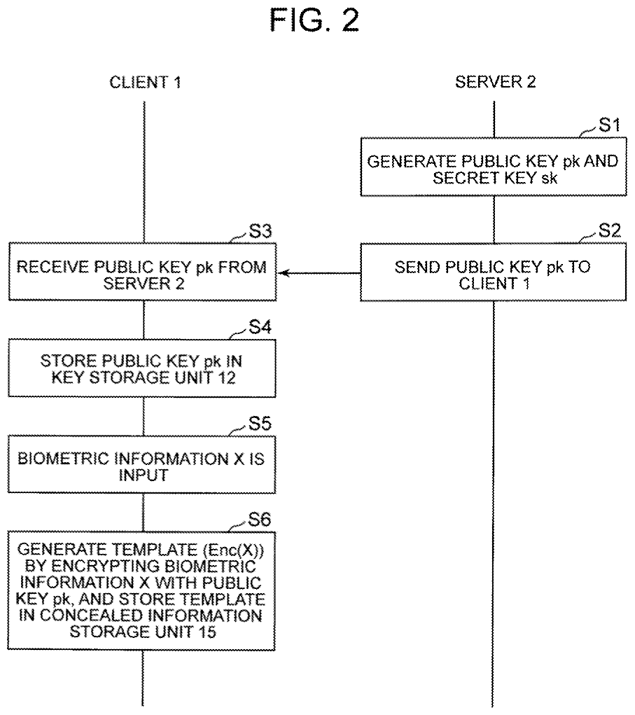

Next, the processing will be explained. FIG. 2 is a flowchart showing an example of processing when storing a template in advance in the concealed information storage unit 15 of the client 1. The detailed explanation is omitted for the matters already explained.

First, the key generation unit 21 of the server 2 generates the public key pk and the secret key sk (step S1). At this time, the key generation unit 21 generates the public key pk and the secret key sk without using the biometric information X. In addition, the key generation unit 21 stores the generated public key pk and the secret key sk in the key storage unit 22.

Next, the key transmission unit 23 sends the public key pk generated in step S1 to the client 1 (step S2).

Then, the key receiving unit 11 of the client 1 receives the public key pk from the server 2 (step S3). The key receiving unit 11 stores the public key pk in the key storage unit 12 (step S4).

Then, the biometric information X of the registrant is input into the registration information input unit 13 (step S5). Then, the concealing unit 14 generates a template (Enc(X)) by encrypting the biometric information X with the public key pk stored in the key storage unit 12, and stores the template in the concealed information storage unit 15 (step S6).

The above processing described in FIG. 2 may be repeated.

The processing of storing the template in advance is not limited to the example shown in FIG. 2. For example, step S5 may be performed before step S1.

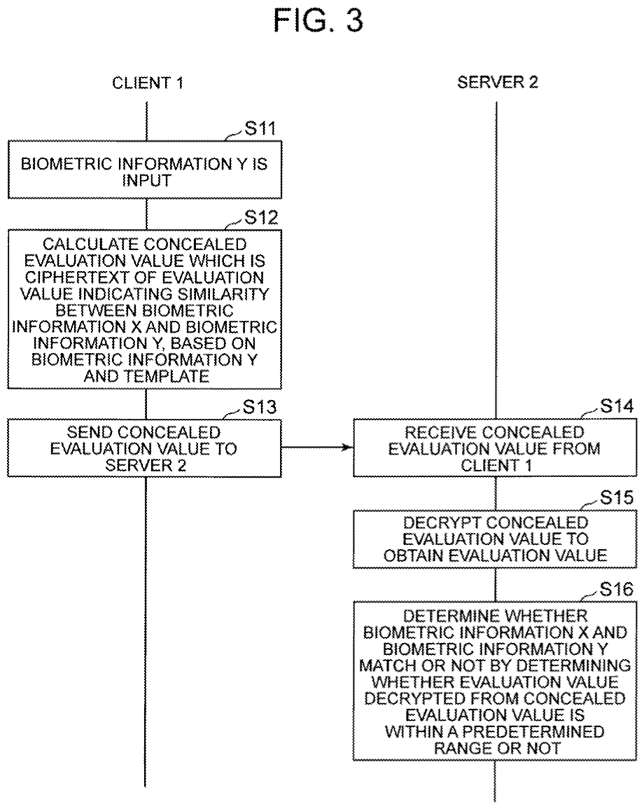

FIG. 3 is a flowchart showing an example of processing when authentication is performed. The detailed explanation is omitted for the matters already explained.

First, the biometric information Y of the authenticated person is input into the matching information input unit 16 (step S11).

Next, the concealed evaluation value calculation unit 17 calculates the concealed evaluation value, that is the data which is ciphertext of the evaluation value indicating similarity between the biometric information X and the biometric information Y, based on the biometric information Y input in step S11 and the template (Enc(X)) stored in the concealed information storage unit 15 (step S12). In step S12, the concealed evaluation value calculation unit 17 calculates the concealed evaluation value without decrypting Enc(X).

Next, the concealed evaluation value transmission unit 18 sends the concealed evaluation value calculated in step S12 to the server 2 (step S13).

Then, the concealed evaluation value receiving unit 24 of the server 2 receives the concealed evaluation value from the client 1 (step S14).

Next, the determination unit 25 decrypts the concealed evaluation value to obtain the evaluation value with the secret key sk stored in the key storage unit 22 (step S15). This secret key sk has been generated in step S1.

Next, the determination unit 25 determines whether the biometric information X and the biometric information Y match or not by determining whether the evaluation value decrypted from the concealed evaluation value is within a predetermined range or not (step S16).

The above processing explained referring to in FIG. 3 may be repeated.

Next, various specific examples of evaluation values that indicate the similarity between the biometric information X and the biometric information Y. In the following explanation, it is assumed that both the biometric information X and the biometric information Y are n-dimensional vectors. Each element of X is represented as X=(x₁, . . . , xₙ), and each element of Y is represented as Y=(y₁, . . . , yₙ). The symbol i denotes 1, . . . , n.

[Hamming Distance]

The evaluation value of the similarity between the biometric information X and the biometric information Y may be Hamming distance between the biometric information X and the biometric information Y. The following is an example of the process when the evaluation value is the Hamming distance.

When the evaluation value is the Hamming distance, it is assumed that each element x₁ to xₙ of the biometric information X and each element y₁ to yₙ of the biometric information Y are 0 or 1.

The Hamming distance in this example is a number of elements of different values that exist in the corresponding positions. Hereafter, the Hamming distance between the biometric information X and the biometric information Y is denoted as dist_{H} ((x₁, . . . , xₙ), (y₁, . . . , yₙ)).

When the evaluation value is the Hamming distance, the concealing unit 14 encrypts each element x₁ to xₙ of X with the public key pk, calculates Σxᵢ, and encrypts Σxᵢ with the public key pk when the biometric information X is input. Then, the concealing unit 14 stores each ciphertext in the concealed information storage unit 15 as a template. The ciphertext of xᵢ is denoted as Enc(xᵢ). The ciphertext of Σxᵢ is denoted as Enc(Σxᵢ). Therefore, in this example, the concealing unit 14 generates Enc(x₁), . . . , Enc(xₙ), and Enc(Σxᵢ), and stores these data in the concealed information storage unit 15. Enc(x₁), . . . , Enc(xₙ) and Enc(Σxᵢ) correspond to the template.

The ciphertext of the Hamming distance dist_{H}((x₁, . . . , xₙ), (y₁, . . . , yₙ)) is denoted as Enc(dist_{H}((x₁, . . . , xₙ), (y₁, . . . , yₙ))). Next, the calculation of Enc(dist_{H}((x₁, . . . , xₙ), (y₁, . . . , yₙ))) by the concealed evaluation value calculation unit 17, when the biometric information Y is input, will be explained.

The concealed evaluation value calculation unit 17 calculates Enc(dist_{H}((x₁, . . . , xₙ), (y₁, . . . , yₙ))) without decrypting each data (Enc(x₁), . . . , Enc(xₙ), Enc(Σxᵢ)) contained in the template.

Here, the Hamming distance dist_{H}((x₁, . . . , xₙ), (y₁, . . . , yₙ)) can be transformed as shown in Equation (3) below. The concealed evaluation value calculation unit 17 calculates the encrypted Hamming distance by using the fact that the Hamming distance can be transformed as shown in Equation (3) below.

$$\begin{matrix}{dist}_{H} ( ( {x}_{1} , … , {x}_{n} ) , ( {y}_{1} , … , {y}_{n} ) ) = Σ \vert {x}_{i} - {y}_{i} \vert \\ = Σ {x}_{i} + Σ {y}_{i} - 2 \cdot Σ {x}_{i} \cdot {y}_{i}\end{matrix} \qquad ( 3 )$$

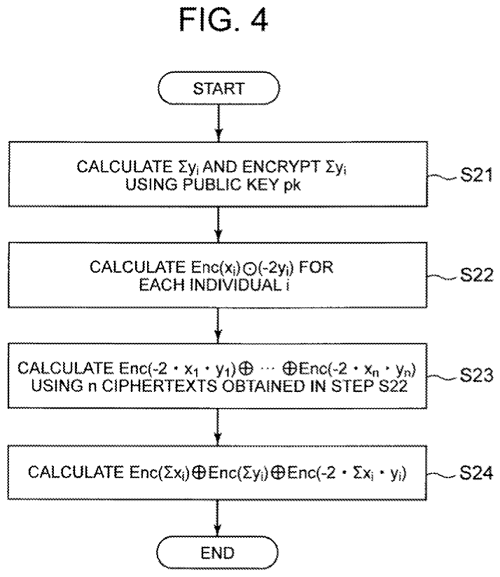

FIG. 4 is a flowchart showing an example of processing of calculating an encrypted Hamming distance. Steps S21 to S24 shown below are an example of the processing of step S12 shown in FIG. 3.

First, when the biometric information Y=(y₁, . . . , yₙ) is input, the concealed evaluation value calculation unit 17 calculates Σyᵢ using each element y₁ to yₙ of Y. Then, the concealed evaluation value calculation unit 17 encrypts Σyᵢ using the public key pk (step S21). The ciphertext of Σyᵢ is denoted as Enc(Σyᵢ).

Next, the concealed evaluation value calculation unit 17 calculates the following values using Enc(xᵢ) contained in the template and yᵢ for each individual i (i=1, . . . , n) (step S22).

Enc(xᵢ)⊙(−2yᵢ) [Math. 5]

The result of this calculation is Enc(−2·xᵢ·yᵢ). By step S22, n ciphertexts are calculated.

Next, the concealed evaluation value calculation unit 17 calculates the following values using n ciphertexts obtained in step S22 (step S23).

Enc(−2·x₁·y₁)⊕ . . . ⊕Enc(−2·xₙ·yₙ) [Math. 6]

The result of this calculation is Enc(−2·Σxᵢ·yᵢ).

Next, the concealed evaluation value calculation unit 17 calculates the following values using Enc(Σxᵢ) contained in the template, Enc(Σyᵢ) obtained in step S21, and Enc(−2·Σxᵢ·yᵢ) obtained in step S23 (step S24).

Enc(Σxᵢ)⊕Enc(Σyᵢ)⊕Enc(−2·Σxᵢ·yᵢ) [Math. 7]

The result of this calculation is Enc(Σxᵢ+Σyᵢ−2·Σxᵢ·yᵢ)=Enc(dist_{H}((x₁, . . . , xₙ), (y₁, . . . , yₙ))). Therefore, the result of the calculation in step S24 is the ciphertext (concealed evaluation value) of the Hamming distance between the biometric information X and the biometric information Y.

When the concealed evaluation value receiving unit 24 of the server 2 receives this data from the concealed evaluation value transmission unit 18 of the client 1, the determination unit 25 decrypts this data (Enc(Σxᵢ+Σyᵢ−2·Σxᵢ·yᵢ)) with the secret key sk to obtain the Hamming distance. Then, the determination unit 25 determines whether the biometric information X and the biometric information Y match or not by determining whether the decrypted Hamming distance is a value within a predetermined range or not.

[Squared Euclidean Distance]

The evaluation value of the similarity between the biometric information X and the biometric information Y may be a squared Euclidean distance between the biometric information X and the biometric information Y. The following is an example of the process when the evaluation value is the squared Euclidean distance.

Hereinafter, the squared Euclidean distance between the biometric information X and the biometric information Y is denoted as dist_{E}((x₁, . . . , xₙ), (y₁, . . . , yₙ)).

When the evaluation value is the squared Euclidean distance, the concealing unit 14 encrypts each element x₁ to xₙ of X with the public key pk, calculates Σ(xᵢ)², and encrypts Σ(xᵢ)² with the public key pk when the biometric information X is input. Then, the concealing unit 14 stores each ciphertext in the concealed information storage unit 15 as a template. As mentioned above, the ciphertext of xᵢ is denoted as Enc(xᵢ). The ciphertext of Σ(xᵢ)² is denoted as Enc(Σ(xᵢ)²). Therefore, in this example, the concealing unit 14 generates Enc(x₁), . . . , Enc(xₙ), and Enc(Σ(xᵢ)²), and stores these data in the concealed information storage unit 15. Enc(x₁), . . . , Enc(xₙ), and Enc(Σ(xᵢ)²) correspond to the template.

The ciphertext of dist_{E}((x₁, . . . , xₙ), (y₁, . . . , yₙ)), which is the squared Euclidean distance, is denoted as Enc(dist_{E}((x₁, . . . , xₙ), (y₁, . . . , yₙ))). Next, the calculation of Enc(dist_{E}((x₁, . . . , xₙ), (y₁, . . . , yₙ))) by the concealed evaluation value calculation unit 17, the when biometric information Y is input, will be explained.

The concealed evaluation value calculation unit 17 calculates Enc(dist_{E}((x₁, . . . , xₙ), (y₁, . . . , yₙ))) without decrypting each data (Enc(x₁), . . . , Enc(xₙ), Enc(Σ(xᵢ)²)) contained in the template.

Here, the squared Euclidean distance dist_{E}((x₁, . . . , xₙ), (y₁, . . . , yₙ)) can be transformed as shown in Equation (4) below. The concealed evaluation value calculation unit 17 calculates an encrypted squared Euclidean distance by using the fact that the squared Euclidean distance can be transformed as shown in Equation (4) below.

$$\begin{matrix}{dist}_{E} ( ( {x}_{1} , … , {x}_{n} ) , ( {y}_{1} , … , {y}_{n} ) ) = {Σ ( {x}_{i} - {y}_{i} )}^{2} \\ = {Σ ( {x}_{i} )}^{2} + Σ {( {y}_{i} )}^{2} - 2 \cdot Σ {x}_{i} \cdot {y}_{i}\end{matrix} \qquad ( 4 )$$

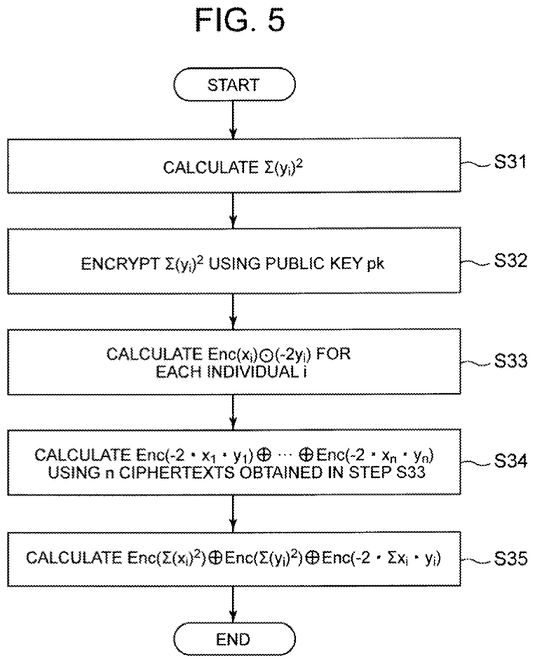

FIG. 5 is a flowchart showing an example of processing of calculating encrypted squared Euclidean distance. Steps S31 to S35 shown below are an example of the processing of step S12 shown in FIG. 3.

First, when the biometric information Y=(y₁, . . . , yₙ) is input, the concealed evaluation value calculation unit 17 calculates Σ(yᵢ)² using each element y₁ to yₙ of Y (step S31).

Then, the concealed evaluation value calculation unit 17 encrypts Σ(yᵢ)² using the public key pk (step S32). The ciphertext of Σ(yᵢ)² is denoted as Enc(Σ(yᵢ)²).

Next, the concealed evaluation value calculation unit 17 calculates the following values using Enc(xᵢ) contained in the template and yᵢ for each individual i (i=1, . . . , n) (step S33).

Enc(xᵢ)⊙(−2yᵢ) [Math. 8]

The result of this calculation is Enc(−2·xᵢ·yᵢ). By step S33, n ciphertexts are calculated.

Next, the concealed evaluation value calculation unit 17 calculates the following values using n ciphertexts obtained in step S33 (step S34).

Enc(−2·x₁·y₁)⊕ . . . ⊕Enc(−2·xₙ·yₙ) [Math. 9]

The result of this calculation is Enc(−2·Σ_{X}·yᵢ).

Next, the concealed evaluation value calculation unit 17 calculates the following values using Enc(Σ(xᵢ)²) contained in the template, Enc(Σ(yᵢ)²) obtained in step S32, and Enc(−2·Σxᵢ·yᵢ) obtained in step S34 (step S35).

Enc(Σ(xᵢ)²)⊕Enc(Σ(yᵢ)²)⊕Enc(−2·Σxᵢ·yᵢ) [Math. 10]

The result of this calculation is Enc(Σ(xᵢ)²+Σ(yᵢ)²−2·Σxᵢ, yᵢ)=Enc(dist_{E}((x₁, . . . , xₙ), (y₁, . . . , yₙ))). Therefore, the result of the calculation in step S35 is the ciphertext (the concealed evaluation value) of the squared Euclidean distance between the biometric information X and the biometric information Y.

When the concealed evaluation value receiving unit 24 of the server 2 receives this data from the concealed evaluation value transmission unit 18 of the client 1, the determination unit 25 decrypts this data (Enc(Σ(xᵢ)²+Σ(yᵢ)²−2·Σxᵢ·yᵢ)) with the secret key sk to obtain the squared Euclidean distance. Then, the determination unit 25 determines whether the biometric information X and the biometric information Y match or not by determining whether the squared decrypted Euclidean distance is a value within a predetermined range or not.

Since it is difficult to calculate the concealed evaluation value that is encrypted Euclidean distance itself, the above process uses the concealed evaluation value that is the encrypted squared Euclidean distance. However, the above process is substantially the same as the process of determining whether the decrypted Euclidean distance is within a predetermined range or not.

[Inner Product]

The evaluation value of the similarity between the biometric information X and the biometric information Y may be an inner product of the biometric information X and the biometric information Y. The following is an example of the process when the evaluation value is the inner product.

In the following, the inner product of the biometric information X and the biometric information Y is Σxᵢ·yᵢ.

When the evaluation value is the inner product, the concealing unit 14 encrypts each element x₁ to xₙ of X with the public key pk when the biometric information X is input. Then, the concealing unit 14 stores each ciphertext in the concealed information storage unit 15 as a template. As mentioned above, the ciphertext of xᵢ is denoted as Enc(xᵢ). Therefore, in this example, the concealing unit 14 generates Enc(x₁), . . . , Enc(xₙ), and stores these data in the concealed information storage unit 15. Enc(x₁), . . . , Enc(xₙ) correspond to the template.

The ciphertext of the inner product Σxᵢ·yᵢ is expressed as Enc(Σxᵢ·yᵢ). Next, the calculation of Enc(Σxᵢ·yᵢ) by the concealed evaluation value calculation unit 17, when the biometric information Y is input, will be explained.

The concealed evaluation value calculation unit 17 calculates Enc(Σxᵢ·yᵢ) without decrypting each data (Enc(x₁), . . . , Enc(xₙ)) contained in the template.

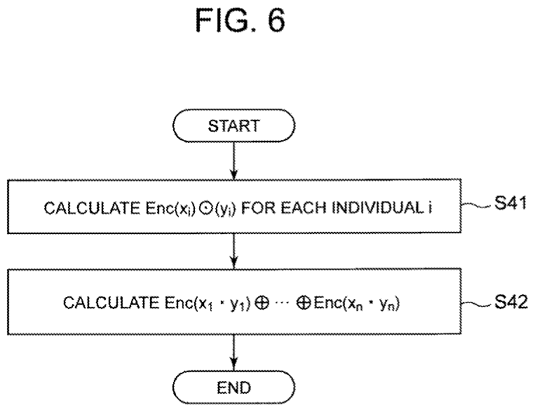

FIG. 6 is a flowchart showing an example of processing of calculating an encrypted inner product. Steps S41 to S42 shown below are an example of the processing of step S12 shown in FIG. 3.

First, when the biometric information Y=(y₁, . . . , yₙ) is input, the concealed evaluation value calculation unit 17 calculates the following values using Enc(xᵢ) contained in the template and yᵢ for each individual i (i=1, . . . , n) (step S41).

Enc(xᵢ)⊙(yᵢ) [Math. 11]

The result of this calculation is Enc(Σxᵢ·yᵢ). By step S41, n ciphertexts are calculated.

Next, the concealed evaluation value calculation unit 17 calculates the following values using n ciphertexts obtained in step S41 (step S42).

Enc(x₁·y₁)⊕ . . . ⊕Enc(xₙ·yₙ) [Math. 12]

The result of this calculation is Enc(Σxᵢ·yᵢ). Therefore, the result of the calculation in step S42 is the ciphertext (concealed evaluation value) of the inner product Σxᵢ·yᵢ of the biometric information X and the biometric information Y.

When the concealed evaluation value receiving unit 24 of the server 2 receives this data from the concealed evaluation value transmission unit 18 of the client 1, the determination unit 25 decrypts this data (Enc(Σxᵢ·yᵢ)) with the secret key sk to obtain the inner product of the biometric information X and the biometric information Y. Then, the determination unit 25 determines whether the biometric information X and the biometric information Y match or not by determining whether the decrypted inner product is a value within a predetermined range or not.

The calculation of the inner product can be applied, for example, to the calculation of a similarity index such as normalized cross-correlation, zero-mean normalized cross-correlation or the like. The inner product of normalized vectors is the normalized cross-correlation. The inner product of zero-mean normalized vectors is the zero-mean normalized cross-correlation.

According to this example embodiment, the key generation unit 21 of the server 2 generates the public key pk and the secret key sk without using the biometric information X. Then, the key receiving unit 11 of client 1 receives the public key pk from server 2 and stores it in the key storage unit 12 of client 1. When the biometric information X is input to the client 1, the concealing unit 14 generates a template by encrypting the biometric information X using the public key pk generated without using the biometric information X, and stores the template in the concealed information storage unit 15 of the client 1. Therefore, according to this example embodiment, the template can be stored in the client 1. Since the template is encrypted, leakage of the biometric information X or part of X from the template can be prevented. Furthermore, even if the template and the public key pk are stolen together from the client 1, leakage of the biometric information X or part of X can be prevented, because data in the template cannot be decrypted by the public key pk. In addition, since server 2 does not have the biometric information X at the stage of template registration on the client 1 side, leakage of the biometric information X or part of X from server 2 can also be prevented.

At the time of authentication, the concealed evaluation value calculating unit 17 calculates a concealed evaluation value that is a ciphertext of an evaluation value indicating similarity between the biometric information X and the biometric information Y, without decrypting each data contained in the template. Then, when the concealed evaluation value receiving unit 24 of the server receives the concealed evaluation value, the determination unit 25 decrypts the concealed evaluation value and determines whether the biometric information X and the biometric information Y match or not by determining whether the evaluation value decrypted from the concealed evaluation value is within a predetermined range or not. Therefore, in the process of obtaining the determination result whether the biometric information X and the biometric information Y match or not, the data obtained by decrypting is the evaluation value, and the biometric information X is not decrypted from the template. In addition, it is the concealed evaluation value that is sent to the server 2, and the template is never sent to the server 2. Therefore, even in the process of obtaining an authentication result, it is possible to prevent leakage of the biometric information X or part of X from the template.

As described above, even when a template is stored in client 1, it is possible to prevent leakage of the biometric information X from client 1, and it is also possible to prevent leakage of the biometric information X in the process of obtaining the authentication result.

Next, after explaining an online brute force attack, modification of this invention will be explained. The online brute force attack is an attack method in which an attacker tries to succeed in authentication by using information (for example, a template) obtained by the attacker to select information to be sent to the server in a brute force manner and repeatedly attempt authentication. If the attacker succeeds in authentication through an online brute force attack, we can say that the biometric information has been leaked to the attacker.

Against an online brute force attack, for example, the server may block access to the server if repeated authentication failures occur in succession. In the above example embodiment, the key generation unit 21 generates a set of a public key pk and a secret key sk, and the key transmission unit 23 sends the same public key pk to each client 1. In other words, each individual client 1 has a common public key pk in its memory. In this case, since the above countermeasure would also block access from legitimate users, the above countermeasure is not appropriate. It is also possible to assign an ID (IDentification) to each client 1, and in step S13 (refer to FIG. 3), the concealed evaluation value transmission unit 18 transmits a concealed evaluation value and the ID assigned to the client 1. The server 2 may then block the acceptance of the ID and the concealed evaluation value when there are repeated authentication failures for the same ID. However, even in this case, an attacker can continue the online brute force attack by changing the ID if the acceptance is blocked by the server.

In the following modification of the example embodiment of the invention, robustness against online brute force attacks is achieved. Hereinafter, a modification is described with referring to FIG. 1. It is assumed that there are multiple clients 1.

In this modification, the key generation unit 21 generates, for each client 1, a pair of a public key pk and a secret key sk unique to the client 1. In addition, the key generation unit 21 assigns an ID unique to client 1 for each client 1, and corresponds the public key pk and secret key sk unique to client 1 to the ID assigned to the client 1 for each client 1. For any client 1, the key generation unit 21 generates the public key pk and the secret key sk without using the biometric information X.

As a result, a set of ID, the public key pk, and the secret key sk is obtained for each client 1. The key generation unit 21 stores the pair of ID, the public key pk, and the secret key sk for each client 1 in the key storage unit 22.

The key transmission unit 23 sends the ID and public key pk corresponding to the client 1 to which the key is to be sent to the client 1. The key receiving unit 11 of client 1 receives the ID and the public key pk corresponding to the client 1, and stores the ID and the public key pk in the key storage unit 12. When sending the concealed evaluation value to the server 2, the concealed evaluation value transmission unit 18 of the client 1 also sends the ID assigned to the client 1 (the ID stored in the key storage unit 12). In other words, the concealed evaluation value transmission unit 18 of client 1 sends the concealed evaluation value and the ID to the server 2.

When the concealed evaluation value receiving unit 24 of the server 2 receives the concealed evaluation value and the ID, the determination unit 25 reads the secret key sk corresponding to the ID from the key storage unit 22 and obtains the evaluation value by decrypting the concealed evaluation value with the secret key sk. Then, the judging unit 25 determines whether the biometric information X and the biometric information Y match or not by determining whether the evaluation value decrypted from the concealed evaluation value is within a predetermined range or not.

In addition, if the authentication to the concealed evaluation value accepted with the same ID fails for a predetermined number of times consecutively, the determination unit 25 determines that the sender is an attacker and blocks the acceptance of the concealed evaluation value sent with the ID. Thus, online brute force attacks can be prevented.

In this modification, even if the acceptance of the concealed evaluation value sent with the ID is blocked as described above, access from a legitimate user using a client 1 (i.e., a client 1 that is not the target of the attack) that is assigned an ID different from the ID used by the attacker is not blocked. That is because the client 1 of the legitimate user can send the ID and the concealed evaluation value assigned to the client 1 to the server, and the determination unit 25 of the server 2 can decrypt the concealed evaluation value with the secret key sk corresponding to the ID, and determine whether the evaluation value decrypted from the concealed evaluation value is a value within the predetermined range or not.

In addition, the determination unit 25 may determine that a source of the ID and the concealed evaluation value is the attacker, if the determination unit 25 cannot decrypt the concealed evaluation value by the secret key sk corresponding to the received ID. In this case, even if the attacker changes the ID when acceptance is blocked by the server 2, the ID is not the ID assigned to the client 1 used by the attacker. Therefore, the secret key corresponding to the changed ID by the attacker will not obtain the evaluation value by decrypting the concealed evaluation value, and the attacker will not be able to continue the online brute force attack.

Thus, by having the key generation unit 21 generate a pair of the public key pk and the secret key sk unique to each client 1, it is possible to prevent the leakage of the biometric information even against online brute force attacks.

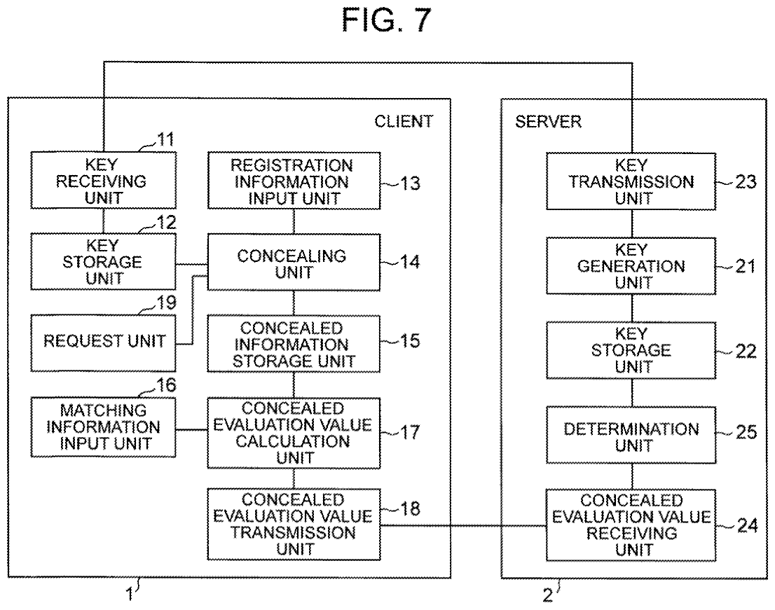

When the concealing unit 14 generates the template, the client 1 may request the public key from the server 2, and the concealing unit 14 may generate the template by using the public key. FIG. 7 is a block diagram showing an example of the configuration in this case. The matters already described are marked with the same sign as in FIG. 1, and the description is omitted. In this modification, as shown in FIG. 7, client 1 includes a request unit 19.

The request unit 19 requests the server 2 to generate and provide a public key when the concealing unit 14 generates a template. The request unit 19 is realized, for example, by a CPU that operates according to the program for the client and a communication interface.

When the server 2 receives a request from the request unit 19 to generate and provide a public key, the key generation unit 21 of the server 2 generates a new public key pk and a new secret key sk in response to the request. Then, the key transmission unit 23 sends the public key pk to the client 1, and the key generation unit 21 stores the secret key sk in the key storage unit 22. When the key receiving unit 11 of the client 1 receives the public key pk sent in response to the request, the key receiving unit 11 stores the public key pk in the key storage unit 12. After the new public key pk is stored in the key storage unit 12, the concealing unit 14 generates a template using the public key pk. According to this configuration, the public key pk is updated for each template generation, and the template can be generated with the updated public key pk.

In the example embodiment of the present invention and its modification, the predetermined range used by the determination unit 25 of the server 2 in step S16 may be changed for each user or for each client. In addition, this predetermined range may also be changed according to external factors or the like. Examples of external factors include the frequency of authentication received by the server 2, the frequency of suspicious accesses, the state of the network and CPU load, and so on. By changing the predetermined range, the load can be reduced.

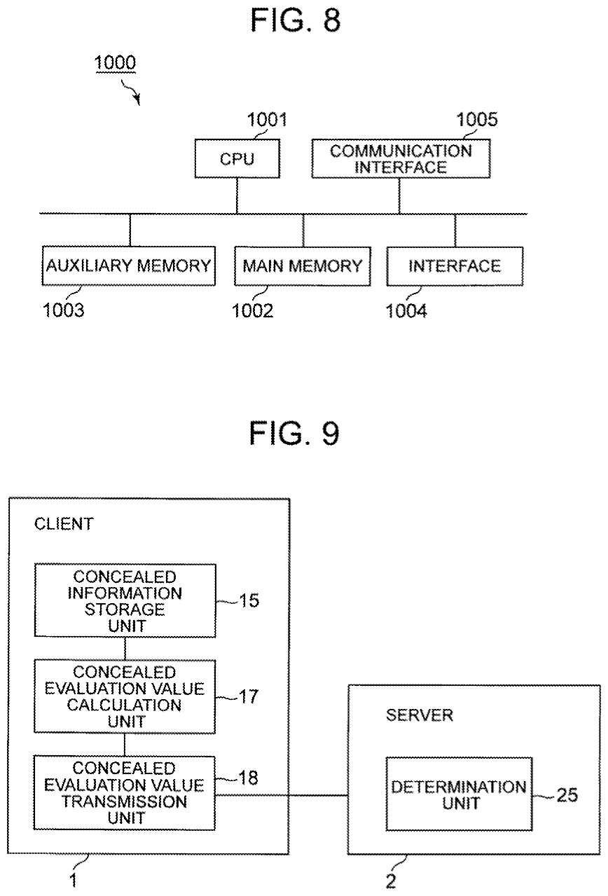

FIG. 8 is a schematic block diagram of a configuration example of a computer for each of the client 1 and the server 2 in an example embodiment or its modification. As is explained below with reference to FIG. 8, the computer used as the client 1 and the computer used as the server 2 are separate computers.

The computer has a CPU 1001, a main memory 1002, an auxiliary memory 1003, an interface 1004, and a communication interface 1005.

The client 1 and the server 2 in the example embodiment of the present invention and its modification are realized by a computer 1000. However, as described above, the computer used as the client 1 and the computer used as the server 2 are separate computers.

The operation of the computer 1000 that realizes the client 1 is stored in the auxiliary memory 1003 in the form of a program for the client. The CPU 1001 reads the program for the client from the auxiliary memory 1003, deploys the program in the main memory 1002, and executes the operation of the client 1 described in the above example embodiment and its modification according to the program for the client.

The operation of the computer 1000 that realizes the server 2 is stored in the auxiliary memory 1003 in the form of a program for the server, and the CPU 1001 reads the program for the server from the auxiliary memory 1003, deploys the program to the main memory 1002, and executes the operation of the server 2 described in the above example embodiment and its modification according to the program for the server.

The auxiliary memory 1003 is an example of a non-transitory tangible medium. Other examples of non-transitory tangible media are a magnetic disk, an optical magnetic disk, a CD-ROM (Compact Disk Read Only Memory), a DVD-ROM (Digital Versatile Disk Read Only Memory), a semiconductor memory, and the like, which are connected through the interface 1004. When the program is delivered to the computer 1000 through a communication line, the computer 1000 that receives the delivery may deploy the program into the main memory 1002 and operate according to the program.

Some or all of the components of the client 1 may be realized by general-purpose or dedicated circuitry, processors, or a combination of these. They may be configured by a single chip or by multiple chips connected through a bus. Some or all of the components may be realized by a combination of the above-mentioned circuits, etc. and a program. The configures are also true for the server 2.

Next, a summary of the present invention will be described. FIG. 9 is a block diagram showing a summarized matching system of the present invention. The matching system comprises a client 1 and a server 2. The client 1 comprises a concealed information storage unit 15, a concealed evaluation value calculation unit 17, and a concealed evaluation value transmission unit 18. The server 2 comprises a determination unit 25.

The concealed information storage unit 15 stores the concealed information generated by concealing the registration information with a public key.

The concealed evaluation value calculation unit 17 calculates the concealed evaluation value of the evaluation value indicating similarity between the registration information and the matching information input for matching with the registration information, based on the matching information and the concealed information.

The concealed evaluation value transmission unit 18 sends the concealed evaluation value to the server 2.

The determination unit 25 determines whether the matching information and the registration information match or not, based on the evaluation value obtained by cancelling concealment of the concealed evaluation value received from the concealed evaluation value transmission unit 18 with a secret key corresponding to the public key.

According to such a configuration, the registration information itself is not stored, but the concealed information generated by concealing the registration information with a public key is stored in the concealed information storage unit 15. Therefore, it is possible to prevent leakage of the registration information from the client 1.

In addition, in the process of obtaining the determination result of whether the matching information and the registration information match or not, the data obtained by cancelling concealment is the evaluation value indicating similarity between the registration information and the matching information, and it is not that the concealment of the registration information is canceled. Therefore, leakage of the registration information can also be prevented even in the process of obtaining the determination result of whether the matching information and the registration information match or not.

Therefore, even in the case where the concealed information generated by concealing the registration information is stored in the client, it is possible to prevent leakage of the registration information from the client.

The aforementioned example embodiment of the present invention can be described as supplementary notes mentioned below, but are not limited to the following supplementary notes.

(Supplementary note 1) A matching system comprising a client and a server,
wherein the client comprises:
a concealed information storage unit which stores concealed information generated by concealing registration information with a public key,
a concealed evaluation value calculation unit which calculates a concealed evaluation value of an evaluation value indicating similarity between the registration information and matching information input for matching with the registration information, based on the matching information and the concealed information, and
a concealed evaluation value transmission unit which sends the concealed evaluation value to the server, and
wherein the server comprises:
a determination unit which determines whether the matching information and the registration information match or not, based on the evaluation value obtained by cancelling concealment of the concealed evaluation value received from the concealed evaluation value transmission unit with a secret key corresponding to the public key.

(Supplementary note 2) The matching system according to Supplementary note 1, wherein
the registration information and the matching information are expressed by vectors.

(Supplementary note 3) The matching system according to Supplementary note 2, wherein
the concealed evaluation value calculation unit calculates the concealed evaluation value of the evaluation value stated based on Hamming distance between the registration information and the matching information.

(Supplementary note 4) The matching system according to Supplementary note 2, wherein
the concealed evaluation value calculation unit calculates the concealed evaluation value of the evaluation value stated based on Euclidean distance between the registration information and the matching information.

(Supplementary note 5) The matching system according to Supplementary note 2, wherein
the concealed evaluation value calculation unit calculates the concealed evaluation value of the evaluation value stated based on an inner product of the registration information and the matching information.

(Supplementary note 6) The matching system according to any one of Supplementary notes 1 to 5, wherein
the client comprises a concealing unit which generates the concealed information by concealing input registration information with the public key, and stores the concealed information to the concealed information storage unit.

(Supplementary note 7) The matching system according to Supplementary note 6, wherein
the client comprises a request unit which requests the server to generate and provide the public key when the concealing unit generates the concealed information, and
wherein the concealing unit generates the concealed information by using the public key which the server provides according to a request from the request unit.

(Supplementary note 8) The matching system according to any one of Supplementary notes 1 to 7, wherein
the server comprises:
a key generation unit which generates the secret key and the public key, and
a key transmission unit which sends the public key to the client.

(Supplementary note 9) The matching system according to Supplementary note 8, wherein
the key generation unit generates the secret key and the public key for each client, and corresponds the public key and the secret key to an identification information assigned to the client, and
the key transmission unit sends to the client the secret key and the identification information corresponding to the client, and
the concealed evaluation value transmission unit sends the identification information to the server along with the concealed evaluation value.

(Supplementary note 10) A matching system comprising a client and a server,
wherein the client comprises:
a concealing unit which generates concealed information by concealing input registration information with a public key, and stores the concealed information to a concealed information storage unit.

(Supplementary note 11) The matching system according to Supplementary note 10, wherein
the concealing unit generates the concealed information by concealing the input registration information with the public key provided from the server.

(Supplementary note 12) A client comprising:
a concealed information storage unit which stores concealed information generated by concealing registration information with a public key,
a concealed evaluation value calculation unit which calculates a concealed evaluation value of an evaluation value indicating similarity between the registration information and matching information input for matching with the registration information, based on the matching information and the concealed information, and
a concealed evaluation value transmission unit which sends the concealed evaluation value to a server.

(Supplementary note 13) The client according to Supplementary note 12, comprising
a concealing unit which generates the concealed information by concealing input registration information with the public key, and stores the concealed information to the concealed information storage unit.

(Supplementary note 14) A client comprising
a concealing unit which generates concealed information by concealing input registration information with a public key, and stores the concealed information to a concealed information storage unit.

(Supplementary note 15) A server comprising:
a concealed evaluation value receiving unit which receives a concealed evaluation value of an evaluation value indicating similarity between registration information and matching information input for matching with the registration information from a client, and
a determination unit which determines whether the matching information and the registration information match or not, based on the evaluation value obtained by cancelling concealment of the concealed evaluation value.

(Supplementary note 16) The server according to Supplementary note 15, wherein
the concealed evaluation value is an evaluation value generated by the client based on concealed information generated by concealing the registration information with a public key and the matching information.

(Supplementary note 17) The server according to Supplementary note 16, wherein
the determination unit cancels concealment of the concealed evaluation value with a secret key corresponding to the public key.

(Supplementary note 18) A matching method,
wherein a client, comprising a concealed information storage unit which stores concealed information generated by concealing registration information with a public key,
calculates a concealed evaluation value of an evaluation value indicating similarity between the registration information and matching information input for matching with the registration information, based on the matching information and the concealed information, and
sends the concealed evaluation value to a server, and
wherein the server determines whether the matching information and the registration information match or not, based on the evaluation value obtained by cancelling concealment of the concealed evaluation value received from the client with a secret key corresponding to the public key.

(Supplementary note 19) An information storage method, wherein
a client generates concealed information by concealing input registration information with a public key, and stores the concealed information to a concealed information storage unit.

(Supplementary note 20) A program for a client, implemented in a computer comprising a concealed information storage unit which stores concealed information generated by concealing registration information with a public key and performing as the client, causing the computer to execute:
an evaluation value calculation process of calculating a concealed evaluation value of an evaluation value indicating similarity between the registration information and matching information input for matching with the registration information, based on the matching information and the concealed information, and
an evaluation value transmission process of sending the concealed evaluation value to a server.

(Supplementary note 21) A program for a client, implemented in a computer performing as the client, causing the computer to execute:
a concealing process of generating concealed information by concealing input registration information with a public key, and storing the concealed information to a concealed information storage unit.

(Supplementary note 22) A program for a server, implemented in a computer performing as the server, causing the computer to execute:
an evaluation value receiving process of receiving a concealed evaluation value of an evaluation value indicating similarity between registration information and matching information input for matching with the registration information from a client, and
a determination process of determining whether the matching information and the registration information match or not, based on the evaluation value obtained by cancelling concealment of the concealed evaluation value.

While the present invention has been explained with reference to the example embodiment, the present invention is not limited to the aforementioned example embodiment. Various changes understandable to those skilled in the art within the scope of the present invention can be made to the structures and details of the present invention.

### INDUSTRIAL APPLICABILITY

This invention is suitably applied to a matching system that performs authentication using a client and a server.

### REFERENCE SIGNS LIST

1 Client
2 Server
11 Key receiving unit
12 Key storage unit
13 Registration information input unit
14 Concealing unit
15 Concealed information storage unit
16 Matching information input unit
17 Concealed evaluation value calculation unit
18 Concealed evaluation value transmission unit
21 Key generation unit
22 Key storage unit
23 Key transmission unit
24 Concealed evaluation value receiving unit
25 Determination unit

What is claimed is:

1. A matching system comprising a client and a server,
wherein the client comprises:
a concealed information storage unit which stores concealed information generated by concealing registration information with a public key,
a concealed evaluation value calculation unit which calculates a concealed evaluation value of an evaluation value indicating similarity between the registration information and matching information input for matching with the registration information, based on the matching information and the concealed information, and
a concealed evaluation value transmission unit which sends the concealed evaluation value to the server, and
wherein the server comprises:
a determination unit which determines whether the matching information and the registration information match or not, based on the evaluation value obtained by cancelling concealment of the concealed evaluation value received from the concealed evaluation value transmission unit with a secret key corresponding to the public key.

2. The matching system according to claim 1, wherein
the registration information and the matching information are expressed by vectors.

3. The matching system according to claim 2, wherein
the concealed evaluation value calculation unit calculates the concealed evaluation value of the evaluation value stated based on Hamming distance between the registration information and the matching information.

4. The matching system according to claim 2, wherein
the concealed evaluation value calculation unit calculates the concealed evaluation value of the evaluation value stated based on Euclidean distance between the registration information and the matching information.

5. The matching system according to claim 2, wherein
the concealed evaluation value calculation unit calculates the concealed evaluation value of the evaluation value stated based on an inner product of the registration information and the matching information.

6. The matching system according to claim 1, wherein
the client comprises a concealing unit which generates the concealed information by concealing input registration information with the public key, and stores the concealed information to the concealed information storage unit.

7. The matching system according to claim 6, wherein
the client comprises a request unit which requests the server to generate and provide the public key when the concealing unit generates the concealed information, and
wherein the concealing unit generates the concealed information by using the public key which the server provides according to a request from the request unit.

8. The matching system according to claim 1, wherein
the server comprises:
a key generation unit which generates the secret key and the public key, and
a key transmission unit which sends the public key to the client.

9. The matching system according to claim 8, wherein
the key generation unit generates the secret key and the public key for each client, and corresponds the public key and the secret key to an identification information assigned to the client, and
the key transmission unit sends to the client the secret key and the identification information corresponding to the client, and
the concealed evaluation value transmission unit sends the identification information to the server along with the concealed evaluation value.

10. A matching system comprising a client and a server,
wherein the client comprises:
a concealing unit which generates concealed information by concealing input registration information with a public key, and stores the concealed information to a concealed information storage unit.

11. The matching system according to claim 10, wherein
the concealing unit generates the concealed information by concealing the input registration information with the public key provided from the server.

12. A client comprising:
a concealed information storage unit which stores concealed information generated by concealing registration information with a public key,
a concealed evaluation value calculation unit which calculates a concealed evaluation value of an evaluation value indicating similarity between the registration information and matching information input for matching with the registration information, based on the matching information and the concealed information, and
a concealed evaluation value transmission unit which sends the concealed evaluation value to a server.

13. The client according to claim 12, comprising
a concealing unit which generates the concealed information by concealing input registration information with the public key, and stores the concealed information to the concealed information storage unit.

14. A client comprising
a concealing unit which generates concealed information by concealing input registration information with a public key, and stores the concealed information to a concealed information storage unit.

15. A server comprising:
a concealed evaluation value receiving unit which receives a concealed evaluation value of an evaluation value indicating similarity between registration information and matching information input for matching with the registration information from a client, and
a determination unit which determines whether the matching information and the registration information match or not, based on the evaluation value obtained by cancelling concealment of the concealed evaluation value.

16. The server according to claim 15, wherein
the concealed evaluation value is an evaluation value generated by the client based on concealed information generated by concealing the registration information with a public key and the matching information.

17. The server according to claim 16, wherein
the determination unit cancels concealment of the concealed evaluation value with a secret key corresponding to the public key.

18-22. (canceled)
